(19) United States
(12) Patent Application Publication
(10) Pub. No.: US 2022/0012973 A1
(43) Pub. Date: Jan. 13, 2022

(54) TRANSACTION DEVICE

(71) Applicant: Oki Electric Industry Co., Ltd., Tokyo (JP)

(72) Inventors: Masaru SHIMAKATA, Tokyo (JP); Masakatsu IWASAKI, Tokyo (JP)

(73) Assignee: Oki Electric Industry Co., Ltd., Tokyo (JP)

(21) Appl. No.: 17/294,592

(22) PCT Filed: Oct. 21, 2019
(86) PCT No.: PCT/JP2019/041272

§ 371 Date: May 17, 2021

(30) Foreign Application Priority Data
Nov. 22, 2018 (JP) 2018-218849

(51) Int. Cl. G07D 11/50; G07D 11/18; G07D 11/36; G07D 11/13

(52) U.S. Cl. CPC G07D 11/50; G07D 11/13; G07D 11/36; G07D 11/18

(57) ABSTRACT

A transaction device executes transaction processing relating to a medium, and includes: a medium retention section capable of retaining the medium; plural first storage boxes capable of storing the medium; a second storage box capable of storing the medium and that is detachable with respect to the transaction device; a conveyance section capable of conveying the medium on a conveyance path connecting between the first storage boxes, the second storage box, and the medium retention section; and a classification section provided on the conveyance path and capable of classifying the medium as the medium passes through, wherein the conveyance section being configured to convey the medium from the first storage boxes to the second storage box or from the second storage box to the first storage boxes via the medium retention section and the classification section when performing retrieval, auditing, or replenishment.

### TECHNICAL FIELD

This application claims priority from Japanese Patent Application No. 2018-218849 filed on Nov. 22, 2018, the disclosure of which is incorporated in its entirety by reference herein.

The present disclosure relates to a transaction device.

### Background Art

Automated Teller Machines (ATMs) and Cash Dispensers (CDs) of financial institutions, as well as automated cash registers, semi-automated cash registers, change machines, and cash processing devices, are typical examples of transaction devices that may be installed in branches of financial institutions such as banks, or stores such as convenience stores and supermarkets (see for example Japanese Patent Application Laid-Open (JP-A) No. 2015-201163). Such transaction devices accept cash deposits, payments, and withdrawals in response to transaction contents. The cash handled by such transaction devices, namely a medium such as banknotes, is for example stored by type in storage boxes (i.e., cassettes).

With such cassettes, it is, for example, necessary to pre-insert cash for payout and recover the cash when the cassette becomes full, for example as a result of cash deposits. Moreover, for example, auditing is performed periodically in order to check transaction device records of deposit and withdrawal amounts against the calculated amount of cash actually present inside the cassette. Maintenance operations relating to the medium inside the cassette are therefore performed on such transaction devices in addition to deposits and withdrawals during transactions.

### SUMMARY OF INVENTION

### Technical Problem

In maintenance operations such as those described above, it has been necessary to carry multiple replacement cassettes to the installation site of the transaction device in order to replenish or retrieve the medium. Similarly, when auditing the medium stored inside such cassettes, it has been necessary to replace multiple cassettes, and to prepare a large quantity of banknotes for replenishment.

In consideration of the above circumstances, the present disclosure provides a transaction device that reduces the number of cassettes required for maintenance operations such as auditing, retrieving, and replenishing a medium inside the transaction device, and that allows simple and reliable management of the medium inside the cassettes.

### Solution to Problem

A transaction device of the present disclosure is a transaction device that executes transaction processing relating to a medium. The transaction device includes a medium retention section capable of retaining the medium, plural first storage boxes for storing the medium, a second storage box capable of storing the medium and detachable with respect to the transaction device, a conveyance section capable of conveying the medium on a conveyance path connecting between the first storage boxes, the second storage box, and the medium retention section, and a classification section provided on the conveyance path and capable of classifying the medium as the medium passes through. The conveyance section is configured to convey the medium from the first storage boxes to the second storage box or from the second storage box to the first storage boxes via the medium retention section and the classification section when performing a maintenance operation.

### BRIEF DESCRIPTION OF DRAWINGS

FIG. 1 is a diagram illustrating an external view of a transaction device.

FIG. 2 is a configuration diagram illustrating an internal configuration of a transaction device of an Example 1.

FIG. 3 is a block diagram illustrating a configuration of a transaction device.

FIG. 4 is a diagram illustrating an example in which plural ATMs 100 are installed.

FIG. 5 is a flowchart illustrating an auditing routine of a transaction device.

FIG. 6 is a flowchart illustrating an auditing routine of a transaction device.

FIG. 7 is a flowchart illustrating a retrieval routine of a transaction device.

FIG. 8 is a diagram illustrating an example of a screen display of a transaction device.

FIG. 9 is a flowchart illustrating a replenishment routine of a transaction device.

FIG. 10 is a flowchart illustrating a replenishment routine of a transaction device.

### DESCRIPTION OF EMBODIMENTS

Detailed explanation follows regarding an example of the present disclosure. In the following explanation and the accompanying drawings, sections that are substantially the same or equivalent to each other are allocated the same reference numerals.

### EXAMPLE

Explanation follows regarding a transaction device 100 of an example of the present disclosure, with reference to the accompanying drawings. Note that in the present exemplary embodiment, an example is given of a case in which the transaction device 100 is an automated transaction device (hereinafter also simply referred to as ATM). However, there is no limitation thereto, and the transaction device 100 may, for example, be configured by a cash processing device, an automated cash register, or a change machine.

The ATM 100 is installed, for example, in a branch of a financial institution, and is connected to respective financial institution host computers (hereinafter also simply referred to as hosts) (not illustrated in the drawings). The ATM 100 is capable of executing various transaction processing by communicating with the host computers.

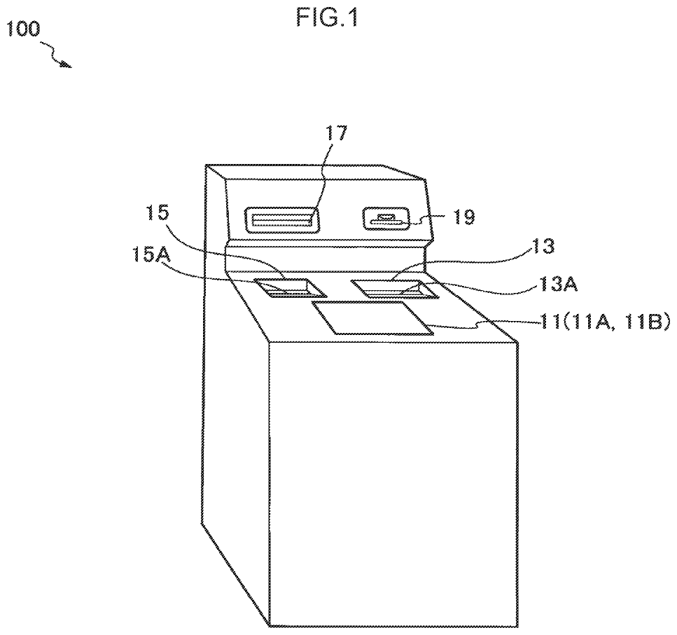

FIG. 1 is a perspective view illustrating the ATM 100 from the front. As illustrated in FIG. 1, an operation/display section 11 is provided on a front side of the ATM 100. The operation/display section 11 is configured by a touch panel including a display 11A serving as a display section, and a touch pad 11B serving as an input section that covers a display face of the display 11A. The display 11A is a display device such as a liquid crystal display device. The touch pad 11B is a touch pad operated by pressure, electrostatic capacitance, or the like.

A person (also referred to as user) utilizing the ATM 100 stands in front of the ATM 100 so as to be able to perform input using the operation/display section 11 and operations such as card insertion.

A maintenance technician (also referred to as operator) of the ATM 100 is able to perform maintenance operations such as auditing, retrieving, and replenishing banknotes by performing input operations on an operation screen displayed on the operation/display section 11.

A banknote deposit/withdrawal section 13 includes an opening that configures an insertion port through which banknotes, serving as a medium, are paid in (inserted) when a deposit is made into the ATM 100. The opening also configures a dispensing port through which banknotes are paid out (dispensed) when a withdrawal is made from the ATM 100. The banknote deposit/withdrawal section 13 is provided with a shutter 13A that is capable of moving so as to open and close the opening.

A coinage deposit/withdrawal section 15 includes an opening that configures an insertion port through which coins, serving as a medium, are inserted when a deposit is made into the ATM 100. As an example, this opening is opened and closed by a shutter 15A; however, there is no limitation to this example, and the shutter 15A may be omitted. The opening also configures a dispensing port through which coins are dispensed when a withdrawal is made.

A passbook insertion/return port 17 configures an insertion port when a passbook is taken in by the ATM 100, and a return port when the passbook is returned by the ATM 100.

A card insertion/return port 19 configures an insertion port when a card holding information that is utilized in a transaction is inserted into the ATM 100, and a return port when the card is removed from the ATM 100 by a customer.

Note that at the end of a transaction, a receipt slip printed with a record of the transaction may be dispensed through the card insertion/return port 19 together with the card. Moreover, for example, at the end of a maintenance operation, a receipt slip printed with a banknote audit outcome or a record of the number of banknotes retrieved may be dispensed through the card insertion/return port 19.

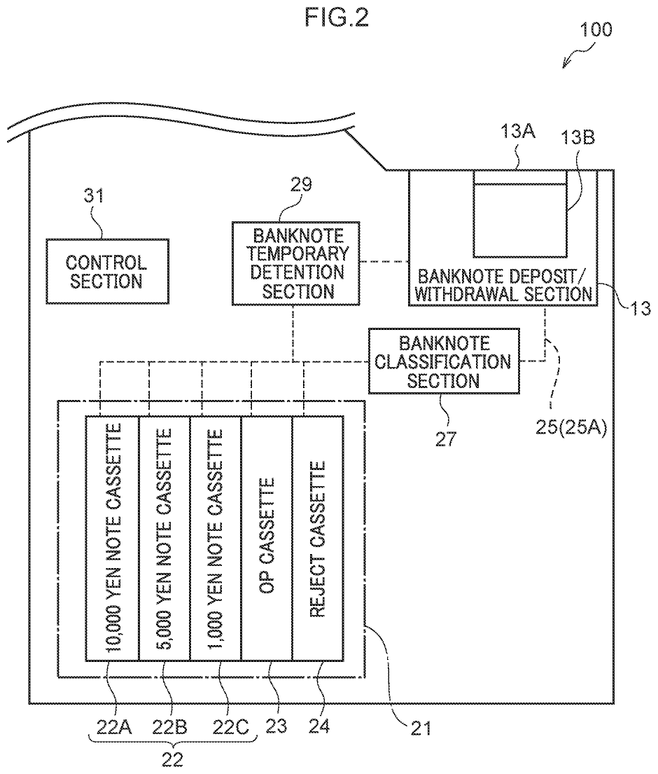

FIG. 2 is a configuration diagram illustrating an internal configuration of the ATM 100. As illustrated in FIG. 2, the banknote deposit/withdrawal section 13 includes a holding section 13B. The holding section 13B is a container having a sufficient capacity to retain banknotes inserted into the banknote deposit/withdrawal section 13 and banknotes to be dispensed by the banknote deposit/withdrawal section 13.

For example, the holding section 13B is capable of retaining anywhere from several tens of banknotes to around one hundred banknotes. The holding section 13B is capable of being opened up to the exterior by for example opening and closing the shutter 13A; however, there is no limitation to this example, and the shutter 13A may be omitted from the banknote deposit/withdrawal section 13.

A banknote storage section 21 includes plural storage boxes (cassettes) that store banknotes. Each of the plural storage boxes are provided so as to be capable of being attached and detached with respect to the ATM 100.

The banknote storage section 21 includes a recycling cassette set 22, serving as plural first storage boxes. The recycling cassette set 22 includes recycling cassettes 22A, 22B, and 22C. The recycling cassettes 22A, 22B, and 22C are storage boxes equipped with functionality to both store and discharge banknotes. The respective cassettes included in the recycling cassette set 22 are capable of storing inserted banknotes by denomination.

In the present example, the recycling cassette 22A is a cassette for 10,000 yen notes, the recycling cassette 22B is a cassette for 5,000 yen notes, and the recycling cassette 22C is a cassette for 1,000 yen notes. Of course, there is no limitation to this example. For example, the recycling cassettes 22A, 22B may be cassettes for 100,000 rupiah notes, and the recycling cassette 22C may be a cassette for 50,000 rupiah notes.

The banknote storage section 21 also includes an operation (OP) cassette 23. The OP cassette 23 is a storage box equipped with functionality to both store and discharge banknotes. The OP cassette 23 is attachable and detachable with respect to the ATM 100.

For example, the OP cassette 23 is not loaded to the ATM 100 when the ATM 100 is executing transaction processing, but is loaded to the ATM 100 during a maintenance operation of the ATM 100.

Alternatively, for example, configuration may be made such that even if the OP cassette 23 is loaded to the ATM 100, banknotes are neither stored in the OP cassette 23 nor discharged from the OP cassette 23 when the ATM 100 is executing transaction processing, but banknotes are stored in the OP cassette 23 or discharged from the OP cassette 23 during a maintenance operation of the ATM 100.

Specifically, during a maintenance operation, banknotes stored inside the recycling cassette set 22 may be retrieved using the OP cassette 23. Alternatively, during a maintenance operation, the OP cassette 23 may be loaded to the ATM 100 in a state stored with replenishment banknotes, and the replenishment banknotes may be then stored by denomination in the respective cassettes of the recycling cassette set 22.

The banknote storage section 21 also includes a reject (RJ) cassette 24. The RJ cassette 24 is a cassette into which reject banknotes such as a counterfeit note or a damaged note are placed in cases in which banknotes are classified as a counterfeit note or a damaged note inside the ATM 100.

Note that the banknote storage section 21 may include a pay-in cassette (not illustrated in the drawings) that is a storage box only equipped with functionality to store banknotes, and that lacks functionality to discharge banknotes.

A conveyance section 25 (illustrated by dashed lines in FIG. 2) includes a conveyance path 25A, this being a path for banknotes. The conveyance section 25 also includes a conveyance mechanism (not illustrated in the drawings) configured by a mechanism for transporting banknotes along the conveyance path 25A using rollers and the like. The conveyance section 25 is provided so as to be capable of conveying banknotes between the banknote deposit/withdrawal section 13 and the respective cassettes included in the banknote storage section 21.

For example, the conveyance section 25 includes sorting mechanisms provided at locations where the conveyance path 25A branches, such that these sorting mechanisms guide the banknotes being conveyed along the conveyance path 25A to a predetermined conveyance destination.

The conveyance section 25 further includes sensors provided on the conveyance path 25A. These sensors detect the positions of banknotes or the passage of banknotes at predetermined locations. Banknotes inserted through the banknote deposit/withdrawal section 13 are conveyed along the conveyance section 25 and led into the respective cassettes of the banknote storage section 21 for storage via the conveyance path 25A. Banknotes to be paid out are led out from the recycling cassette set 22 to the banknote deposit/withdrawal section 13 on the conveyance path 25A.

A banknote classification section 27 is provided at part of the conveyance section 25, and classifies banknotes being conveyed through the ATM 100 interior by the conveyance section 25 according to denomination and authenticity. The banknote classification section 27 acquires data required for banknote classification as the banknotes pass through the banknote classification section 27 on the conveyance path 25A. For example, the banknote classification section 27 may include functionality to acquire data regarding banknote size and imagery, and perform banknote classification based on this data.

A banknote temporary detention section 29 is a region that collects and temporarily detains banknotes being conveyed through the ATM 100 interior, for example banknotes that have been taken in through the banknote deposit/withdrawal section 13 or banknotes that are to be discharged into the banknote deposit/withdrawal section 13. The banknote temporary detention section 29 is capable of collecting and temporarily detaining banknotes during pay-in banknote counting or the like.

The banknote temporary detention section 29 also, for example, temporarily collects banknotes that have been classified as rejects banknotes during a maintenance operation. Such reject banknotes may then be stored in the OP cassette 23 or the reject cassette 24.

A control section 31 is a processor or device that executes the functionality of the ATM 100. Operation control of the ATM 100 is performed by the control section 31. The control section 31 is configured by a central processing unit (CPU) (not illustrated in the drawings), read only memory (ROM), random access memory (RAM), and the like, and functions as a computer. The CPU of the control section 31 implements various functionality by reading and executing various programs stored either in the ROM or externally.

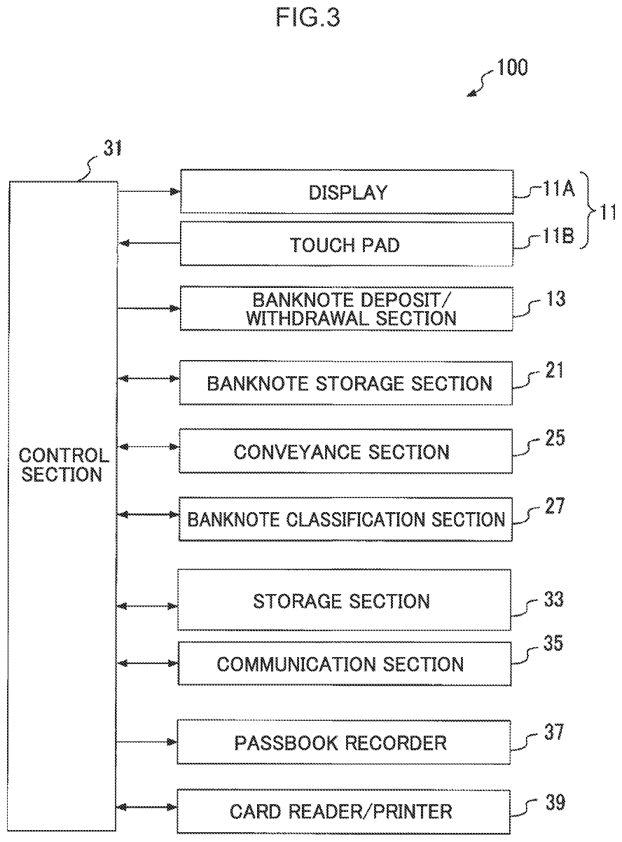

FIG. 3 is a diagram illustrating configuration relating to device control of the ATM 100. The control section 31 is connected to and controls the respective sections of the ATM 100 in order to implement the functionality of the various devices included in the ATM 100.

The control section 31 is connected to respective sections configured by the operation/display section 11, the banknote deposit/withdrawal section 13, the banknote storage section 21, the conveyance section 25, the banknote classification section 27, and so on, and controls these respective sections in order to implement the functionality described above.

For example, the display 11A of the operation/display section displays transaction screens, including various operation screens, messages, and the like, based on operation/display signals supplied from the control section 31. After a region of the touch pad 11B corresponding to content displayed on the display 11A is touched by a person utilizing the touch pad 11B, an operation signal corresponding to the displayed content is supplied to the control section 31. Note that there is no limitation to the touch pad 11B, and hard keys or the like may be employed instead. After the person selects such a hard key corresponding to the content displayed on the display 11A, an operation signal corresponding to the displayed content is supplied to the control section 31.

The banknote storage section 21 for example follows instructions from the control section 31 to open and close shutters of the respective cassettes in order to store banknotes.

The conveyance section 25 for example follows instructions from the control section 31 to actuate the conveyance mechanism including banknote transporting mechanisms such as rollers and blades. For example, when a program relating to a maintenance operation is executed by the control section 31, the conveyance mechanism is actuated so as to convey banknotes to a conveyance destination specified by the program.

The banknote classification section 27 for example supplies the control section 31 with data acquired as banknotes pass through the banknote classification section 27.

A storage section 33 is a storage device configured by a hard disk, flash memory, a solid state drive (SSD), random access memory (RAM), or the like, and stores data required for processing by the control section 31 and data generated during processing as appropriate.

For example, the storage section 33 stores an operating system and various programs such as software for the ATM 100. The various programs may, for example, be acquired from other server devices or the like over a network, or may be recorded on a recording medium and read via a suitable drive device.

A communication section 35 is a network adaptor such as a Network Interface Card (NIC) that follows instructions from the control section 31 to perform external communication, for example to transmit and receive data. For example, the communication section 35 communicates with external equipment such as a host computer generated during transaction processing.

A passbook recorder 37 takes in an account passbook when inserted into the passbook insertion/return port 17 provided at the front of the ATM 100 by a customer. When this is performed, the passbook recorder 37 writes transaction details, a transaction date and time, and so on in the customer's account passbook, as indicated by a transaction outcome signal supplied from the control section 31. After this writing has been completed, the passbook recorder 37 returns the account passbook to the customer through the passbook insertion/return port 17.

A card reader/printer 39 for example takes in a transaction card and reads information held on the transaction card when a customer's transaction card has been inserted into the card insertion/return port 19 serving as a card insertion port provided at the front of the ATM 100. Note that there is no limitation to this example, and the information held on the transaction card may be read as the transaction card enters the card insertion/return port 19 or when the transaction card is taken from the card insertion/return port 19 by the customer. The information held on the transaction card includes, for example, customer information such as a user identification number or an account number. The card reader/printer 39 supplies card information data expressing the read card information to the control section 31.

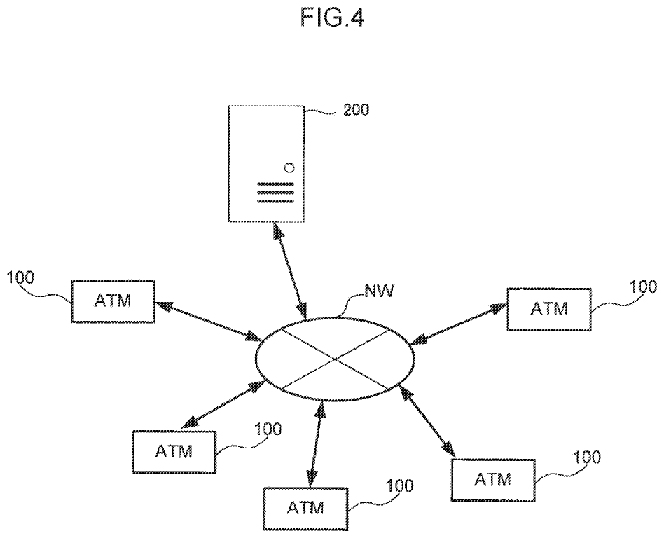

FIG. 4 is a schematic diagram illustrating an example of a maintenance network to which plural ATMs 100 are connected. For example, the plural ATMs 100 may be installed in a single branch of a bank, or may be installed in different branches of a bank. Further, the plural ATMs 100 may be installed in locations other than a bank.

For example, the maintenance network is connected to a maintenance server 200 configuring a server for processing maintenance-related information. For example, the maintenance server employs information from each of the plural ATMs 100 to determine whether a maintenance operation is required for each of the ATMs 100. Moreover, for example, the maintenance server may notify maintenance staff after a maintenance operation has been determined to be required for a given ATM 100.

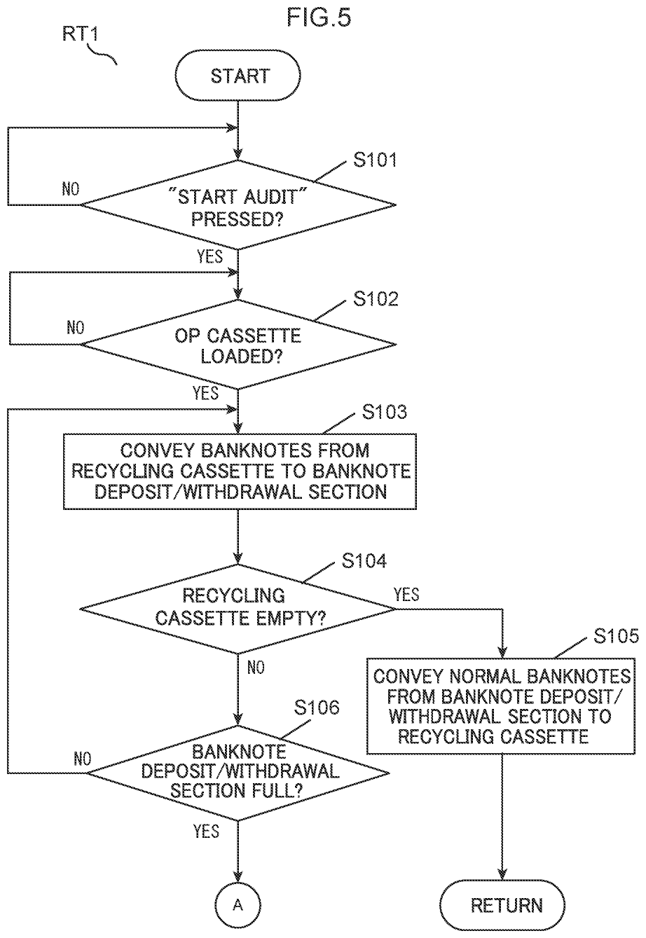

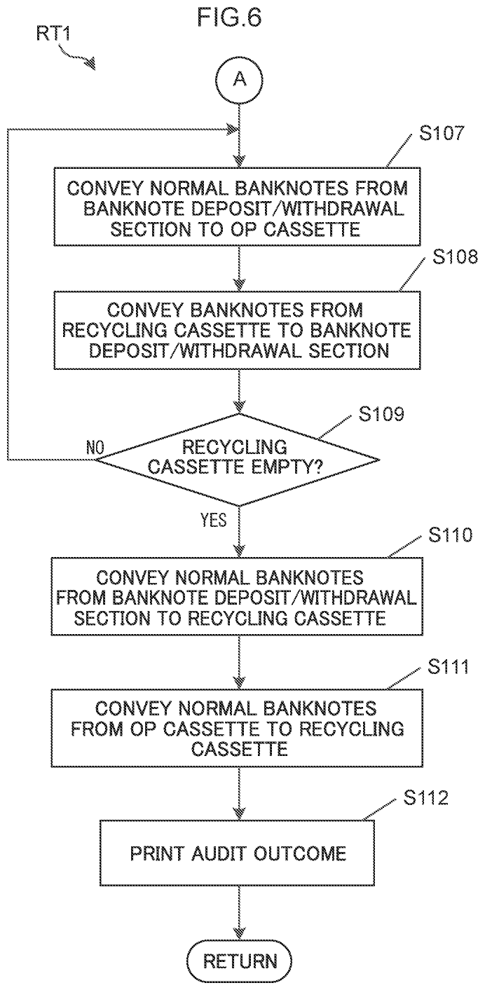

Explanation follows regarding a banknote auditing routine RT1 executed by the control section 31 of the ATM 100, with reference to FIG. 5 and FIG. 6. Explanation follows regarding an example of a case in which auditing is performed for banknotes in the single recycling cassette 22A, serving as a single first storage box included in the recycling cassette set 22 serving as plural first storage boxes.

The control section 31 starts the present routine when, for example, a specialist key has been used to switch an operation mode of the ATM 100 from a normal mode in which transactions are executed to a mode for executing processing related to maintenance operations.

On starting the auditing routine RT1, the control section 31 determines whether or not a “start audit” option has been pressed (step S101). For example, at step S101, the control section 31 displays a maintenance operation selection screen on the display 11A of the operation/display section 11, and determines whether or not the “start audit” option displayed on the selection screen has been selected using the touch pad 11B.

In cases in which the control section 31 determines that the “start audit” option has not been pressed at step S101, step S101 is repeated and determination as to whether or not the “start audit” option has been pressed is performed again.

In cases in which the control section 31 determines that the “start audit” option has been pressed at step S101, the control section 31 determines whether or not the OP cassette 23 has been loaded (step S102). Namely, at step S102, the control section 31 determines whether or not the OP cassette 23 has been loaded into the banknote storage section 21 of the ATM 100. For example, at step S102, determination is made as to whether or not a cassette detection sensor installed to a casing (not illustrated in the drawings) of the banknote storage section 21 has detected the OP cassette 23.

In cases in which the control section 31 determines that the OP cassette 23 has not been loaded at step S102, step S102 is repeated, and determination as to whether or not the OP cassette 23 has been loaded is performed again.

In cases in which the control section 31 determines that the OP cassette 23 has been loaded at step S102, banknotes are conveyed from the recycling cassette 22A to the banknote deposit/withdrawal section 13 (step S103). Namely, at step S103, banknotes are led out from the recycling cassette 22A, passed through the banknote classification section 27, and held in the holding section 13B of the banknote deposit/withdrawal section 13.

After executing step S103, the control section 31 determines whether or not the recycling cassette 22A is empty (step S104). In cases in which the control section 31 determines the recycling cassette 22A to be empty at step S104 (step S104: YES), banknotes are conveyed from the banknote deposit/withdrawal section 13 to the recycling cassette 22A (step S105). Note that the banknotes held in the holding section 13B in cases in which the recycling cassette 22A has been determined to be empty at step S104 are conveyed directly to the recycling cassette 22A without passing through the OP cassette 23 (step S105). The reason for avoiding the OP cassette 23 is that there are no longer any banknotes for audit in the recycling cassette 22A and there is no need to store the banknotes in the OP cassette 23, enabling greater processing efficiency. Moreover, in terms of the sequence in which banknotes are stored in the recycling cassette 22A, the banknotes in the holding section 13B are stored before the banknotes in the OP cassette 23. Also at step S105, the banknotes held in the holding section 13B of the banknote deposit/withdrawal section 13 are classified by the banknote classification section 27, and banknotes classified as normal are then conveyed back to the original recycling cassette 22A. Note that the banknote classification section 27 classifies banknotes as either normal banknotes or damaged banknotes (i.e., reject banknotes). As described above, banknotes classified as normal are conveyed to the recycling cassette 22A. Banknotes classified as reject banknotes, such as a counterfeit note or a damaged note, at step S105 are for example conveyed to the reject cassette 24. In cases in which a banknote is classified as a reject banknote, at least one of the denomination, serial number, or an image of the banknote may be stored in the storage section 33. In cases in which a banknote is classified as a reject banknote, this may be output on the display 11A and/or on a receipt slip either individually for each reject banknote or collectively for all reject banknotes.

In cases in which the control section 31 determines the recycling cassette 22A not to be empty at step S104 (step S104: NO), the control section 31 determines whether or not the banknote deposit/withdrawal section 13 is full (step S106). In cases in which the control section 31 determines the banknote deposit/withdrawal section 13 not to be full at step S106, processing returns to step S103, and conveyance of banknotes from the recycling cassette 22A to the banknote deposit/withdrawal section is resumed.

In cases in which the control section 31 determines the banknote deposit/withdrawal section 13 to be full at step S106, as illustrated in FIG. 6, the banknotes are conveyed from the banknote deposit/withdrawal section 13 to the OP cassette 23 (step S107). Note that when conveying the banknotes from the banknote deposit/withdrawal section 13 to the OP cassette 23 (step S107), the banknotes pass the banknote classification section 27 where they are classified. At step S107, banknotes classified as normal are conveyed to the OP cassette 23, while reject banknotes are conveyed to the banknote temporary detention section 29. Moreover, banknotes are conveyed to the OP cassette 23 at step S107 until the holding section 13B of the banknote deposit/withdrawal section 13 becomes empty. For example, from several tens of banknotes to around one hundred banknotes are conveyed at step S107 according to the holding capacity of the holding section 13B.

After executing step S107, the control section 31 again conveys banknotes from the recycling cassette 22A to the banknote deposit/withdrawal section 13 (step S108). Note that regarding execution of step S108, step S108 may be executed after the presence of banknotes in the recycling cassette 22A has been confirmed, and step S108 to step S110 may be omitted in cases in which no banknotes are present.

After executing step S108, the control section 31 determines whether or not the recycling cassette 22A is empty (step S109). In cases in which the control section 31 determines the recycling cassette 22A not to be empty at step S109 (step S109: NO), processing returns to step S107, and normal banknotes of the banknotes inside the banknote deposit/withdrawal section 13 are again conveyed to the OP cassette 23 while reject banknotes are conveyed to the banknote temporary detention section 29. After this step S107, any banknotes remaining in the recycling cassette 22A are conveyed to the banknote deposit/withdrawal section 13 (step S108).

Namely, at step S107 to step S109, the conveyance section 25 follows instructions from the control section 31 to relocate banknotes from inside the holding section 13B of the banknote deposit/withdrawal section 13 to the OP cassette 23, and repeat conveyance to lead out banknotes from the recycling cassette 22A until no banknotes remain in the recycling cassette 22A.

In other words, at step S103 to step S109, the conveyance section 25 extracts banknotes from the recycling cassette 22A, as a first conveyance, to convey banknotes from the recycling cassette 22A serving as a first storage box to the banknote deposit/withdrawal section 13 serving as a medium retention section, and then stores the banknotes extracted from the recycling cassette 22A in the OP cassette 23, as a second conveyance, to convey banknotes from the banknote deposit/withdrawal section 13 to the OP cassette 23 serving as a second storage box.

In this manner, in the present routine, the banknotes inside the recycling cassette 22A are conveyed to the OP cassette 23 via the banknote deposit/withdrawal section 13 and the banknote classification section 27. In the present routine, the holding section 13B of the banknote deposit/withdrawal section 13 is employed as a buffer to enable uninterrupted conveyance of banknotes from inside the recycling cassette 22A in a single direction in units corresponding to the number of banknotes capable of being held in the holding section 13B.

By contrast, for example were a transaction device having a similar layout for the layout of the banknote storage section 21, the conveyance section 25, and the banknote classification section 27 (see FIG. 2) of the present example to perform auditing without employing the holding section 13B of the banknote deposit/withdrawal section 13 as a buffer, it would be necessary to convey each banknote from the recycling cassette set 22 to the banknote classification section 27, and then convey the banknote classified by the banknote classification section 27 to either the OP cassette 23 or the reject cassette 24 according to the classification result, i.e. normal or damaged, etc. However, for example, in order to prevent collisions between notes under conveyance from the recycling cassette 22A to the banknote classification section 27 and notes under conveyance from the banknote classification section 27 to the OP cassette 23, it would be necessary to switch the conveyance direction for every note conveyed, making efficient conveyance difficult to achieve.

The ATM 100 is thus capable of conveying banknotes from the recycling cassette 22A to the OP cassette 23 for storing via the banknote deposit/withdrawal section 13 and the banknote classification section 27 efficiently and in a short time, despite having the above-described layout.

In cases in which the control section 31 determines the recycling cassette 22A to be empty at step S109 (step S109: YES), as described above for step S105, banknotes classified as normal out of the banknotes fed out from the banknote deposit/withdrawal section 13 are conveyed directly to the recycling cassette 22A without passing through the OP cassette 23 (step S110), and banknotes that have already been stored in the OP cassette 23 are conveyed from the OP cassette 23 to the recycling cassette 22A (step S111). In cases in which the recycling cassette 22A is not empty at step S109, banknotes classified as normal out of the banknotes fed out from the banknote deposit/withdrawal section 13 are conveyed to the OP cassette 23 (S107), while reject banknotes classified as a damaged note, etc. are for example initially conveyed to the banknote temporary detention section 29 and then conveyed to the reject cassette 24 in a group. However, there is no limitation to this example, and reject banknotes may be conveyed directly to the reject cassette 24 without passing through the banknote temporary detention section 29.

At step S111, the control section 31 controls the conveyance section 25 to convey all banknotes in the OP cassette 23 back to the recycling cassette 22A from which the banknotes have been originally extracted. Namely, the conveyance section 25 returns the banknotes that have been extracted from the recycling cassette 22A and stored in the OP cassette 23 to the recycling cassette 22A, as a third conveyance, to convey banknotes from the OP cassette 23 serving as a second storage box to the recycling cassette 22A serving as a single first storage box.

Note that although explanation has been given regarding an example in which the banknotes are conveyed directly to the recycling cassette 22A at step S110, there is no limitation to this example, and banknotes from the banknote deposit/withdrawal section 13 may be initially stored in the OP cassette 23 and then the banknotes may be stored in the recycling cassette 22A from the OP cassette 23.

After executing step S111, the control section 31 prints an audit outcome (step S112). For example, at step S112, the control section 31 controls the card reader/printer 39 to print a receipt slip with an audit outcome including the denomination, number of banknotes, and the like of the banknotes inside the recycling cassette 22A, and then dispense the receipt slip through the card insertion/return port 19. The receipt slip may also be printed with the denomination and/or number of reject banknotes. The receipt slip may also be printed with the serial numbers of reject banknotes. Note that there is no limitation to this example, and for example a receipt slip may be printed once auditing is complete for all of the recycling cassettes 22A to 22C.

After executing step S112, the control section 31 ends the auditing routine RT1 and then repeats execution of the auditing routine RT1. In the present example, the auditing routine RT1 is repeated for each cassette in order to audit the banknotes inside all of the recycling cassettes 22A to 22C in the recycling cassette set 22.

Although explanation of banknote conveyance in the present routine has been given using an example in which banknotes are classified by the banknote classification section 27 on being fed out from the banknote deposit/withdrawal section 13, or classified while being conveyed from the banknote deposit/withdrawal section 13 to the OP cassette 23 (or to the banknote temporary detention section 29) (in the second conveyance), there is no limitation to this example. For example, banknotes may just be classified while being conveyed from the recycling cassette 22A to the banknote deposit/withdrawal section 13 (in the first conveyance). Namely, it is sufficient for banknotes to pass through the banknote classification section 27 and be classified in either the first conveyance or the second conveyance. It is also possible to classify banknotes during both the first conveyance and the second conveyance, and so doing contributes to more credible classification.

As described above, during a maintenance operation involving auditing of banknotes, the ATM 100 enables an empty OP cassette 23 to be loaded, and banknotes inside the recycling cassette 22A to be classified by the banknote classification section 27 and relocated to the OP cassette 23.

When this is performed, banknotes are temporarily held in the holding section 13B of the banknote deposit/withdrawal section 13. This enables uninterrupted conveyance in a single direction despite the layout described above, enabling efficient conveyance that passes through the banknote classification section 27. Namely, simply loading the empty OP cassette 23 enables automatic and efficient auditing in the ATM 100.

Accordingly, for example, there is no need to remove all cassettes subject to auditing and replace them with other cassettes. Namely, fewer cassettes need to be prepared than in cases in which the cassettes subject to auditing are removed and replaced with other cassettes, resulting in less effort being required for the auditing operation. Moreover, action may be taken more promptly in cases in which a transaction outcome by the ATM 100 does not match the audit outcome.

Moreover, for example, there is no need for processing to empty a recycling cassette in order to prepare an empty cassette into which to relocate banknotes during auditing employing the banknote classification section 27.

Accordingly, the ATM 100 enables providing a device that reduces the number of cassettes required in order to audit the medium inside the device, and that allows simple and reliable management of the medium inside the cassettes.

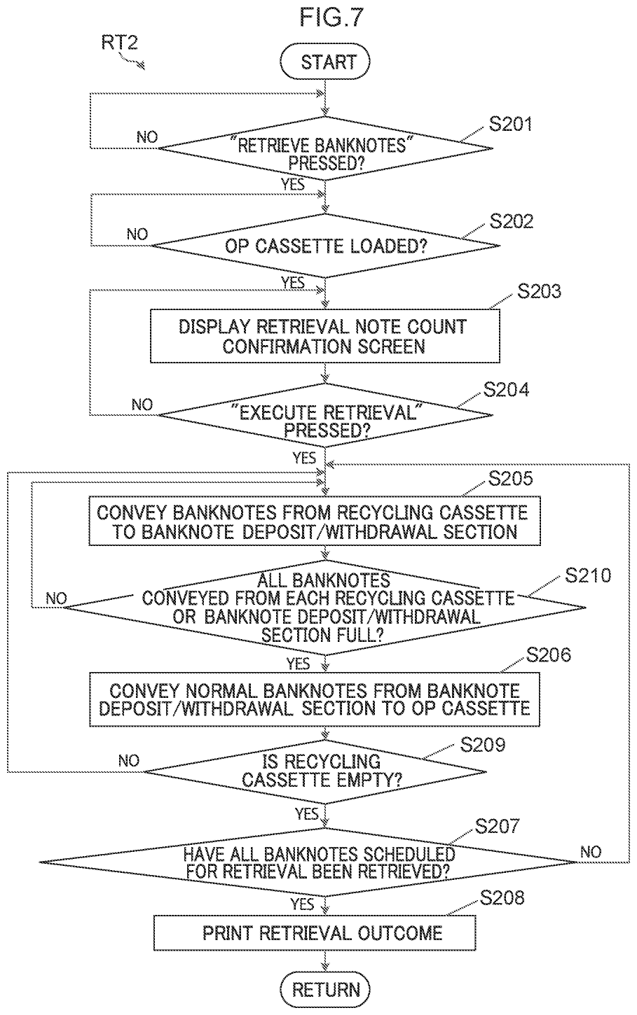

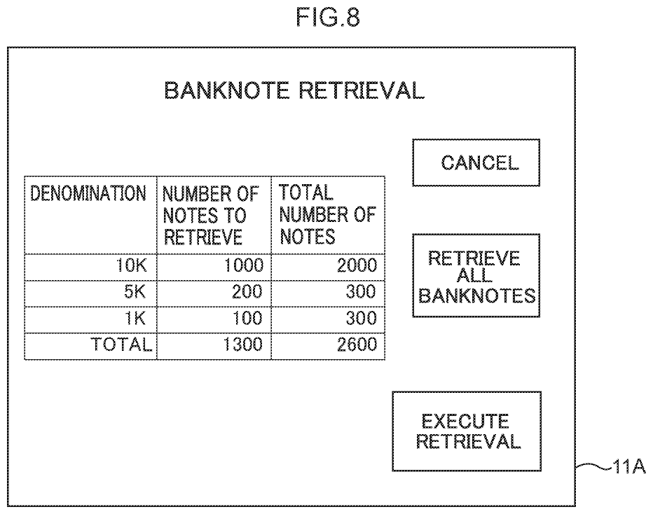

Explanation follows regarding a banknote retrieval routine RT2 executed by the control section 31 of the ATM 100, with reference to FIG. 7 and FIG. 8. Explanation follows regarding an example of a case in which banknotes inside all of the recycling cassettes 22A to 22C included in the recycling cassette set 22 are retrieved.

The control section 31 starts the present routine when, for example, a specialist key has been used to switch an operation mode of the ATM 100 from the normal mode in which transactions are executed to a mode for executing processing related to maintenance operations.

After starting the retrieval routine RT2, the control section 31 determines whether or not a “retrieve banknotes” option has been pressed (step S201). For example, at step S201, the control section 31 displays a maintenance operation selection screen on the display 11A of the operation/display section 11, and determines whether or not the “retrieve banknotes” option displayed on the selection screen has been selected using the touch pad 11B. Note that there is no limitation to this example, and for example hard keys may be employed instead of the touch pad 11B. For example, such hard keys are used to select “retrieve banknotes”, and input a “number of notes to retrieve”.

In cases in which the control section 31 determines that the “retrieve banknotes” option has not been pressed at step S201, step S201 is repeated and determination as to whether or not the “retrieve banknotes” option has been pressed is performed again.

In cases in which the control section 31 determines that the “retrieve banknotes” option has been pressed at step S201, the control section 31 determines whether or not the OP cassette 23 has been loaded (step S202). At step S202, the control section 31 determines whether or not the OP cassette 23 has been loaded into the banknote storage section 21 of the ATM 100.

In cases in which the control section 31 determines that the OP cassette 23 has not been loaded at step S202, step S202 is repeated, and determination as to whether or not the OP cassette 23 has been loaded is performed again.

In cases in which the control section 31 determines that the OP cassette 23 has been loaded at step S202, a retrieval note count confirmation screen is displayed (step S203). For example, at step S203, the control section 31 displays a screen such as that illustrated in FIG. 8 on the display 11A. As illustrated in FIG. 8, the retrieval note count confirmation screen displays a number of notes to retrieve for each denomination, as well as the total number of notes for each banknote denomination already stored in the recycling cassette set 22.

For example, the control section 31 uses a history of transactions executed by the ATM 100 within a predetermined timeframe to compute a number of banknotes to be retrieved from each of the recycling cassettes 22A to 22C, and displays this on the display 11A. For example, the number of banknotes to be retrieved is computed based on trends in deposits and withdrawals performed at the ATM 100 within a predetermined period such that banknotes for withdrawals will not become insufficient, while maximizing the length of time until the respective cassettes become full. At step S203 the control section 31 functions as a first computation section.

Note that at step S203, the control section 31 may accept input through the touch pad 11B to change the number of notes to be retrieved.

After executing step S203, the control section 31 determines whether or not an “execute retrieval” option has been pressed (step S204). For example, at step S204, the control section 31 determines whether or not an “execute retrieval” option displayed on the retrieval note count confirmation screen has been selected using the touch pad 11B.

In cases in which the control section 31 determines that the “execute retrieval” option has not been pressed at step S204, processing returns to step S203, and display of the retrieval note count confirmation screen continues. Note that in cases in which a “cancel” option displayed on the retrieval note count confirmation screen has been selected at step S204, the control section 31 may end the current routine.

In cases in which the control section 31 determines that the “execute retrieval” option has been pressed at step S204, banknotes are conveyed from each of the recycling cassettes 22 to the banknote deposit/withdrawal section 13 (step S205). For example, at step S205, the control section 31 controls the conveyance section 25 to convey the number of banknotes displayed on the retrieval note count confirmation screen from each of the recycling cassettes 22A to 22C to the holding section 13B of the banknote deposit/withdrawal section 13 by cassette. Note that during conveyance of banknotes from each of the recycling cassettes 22 to the banknote deposit/withdrawal section 13 (step S205), in cases in which the holding section 13B of the banknote deposit/withdrawal section 13 is full with stored banknotes (step S210), step S206, described later, is executed. After execution of step S206, in cases in which banknotes are still stored in a first recycling cassette 22 (step S209) the remaining banknotes stored in the first recycling cassette 22 are conveyed to the banknote deposit/withdrawal section 13 (step S205). As described above, the processing of step S205 to step S206 is repeated until no banknotes remain in the first recycling cassette 22 (step S209).

On the other hand, in cases in which further banknotes may still be stored in the holding section 13B following execution of step S205 (step S210), then banknotes stored in a following second recycling cassette 22 are conveyed to the banknote deposit/withdrawal section 13 (step S205).

In cases in which all banknotes scheduled for retrieval from the respective recycling cassettes 22 have been conveyed to the banknote deposit/withdrawal section 13, or the holding section 13B of the banknote deposit/withdrawal section 13 is full (step S210: YES), banknotes classified as normal are conveyed from the banknote deposit/withdrawal section 13 to the OP cassette 23 (step S206). For example, at step S206, the banknotes in the holding section 13B of the banknote deposit/withdrawal section 13 pass through the banknote classification section 27, and all banknotes classified as normal are conveyed to the OP cassette 23. Note that any reject banknotes are conveyed to the reject cassette 24 when all of the banknotes scheduled for retrieval from the respective recycling cassettes 22 have been conveyed to the banknote deposit/withdrawal section 13 (step S210). In cases in which the holding section 13B of the banknote deposit/withdrawal section 13 is full (step S210: YES), any reject banknotes are, for example, initially conveyed to the banknote temporary detention section 29; however there is no limitation to this example, and for example reject banknotes may be conveyed to the reject cassette 24. Moreover, in cases in which a reject banknote arises, at least one of the denomination, serial number, or an image of the reject banknote may be stored in the storage section 33. In cases in which a banknote is classified as a reject banknote, this may be output on the display 11A and/or on a receipt slip, either individually for each reject banknote or collectively for all reject banknotes.

Following execution of step S206 and step S209, the control section 31 determines whether or not all banknotes scheduled for retrieval have been retrieved in the OP cassette 23 (step S207). For example, at step S207, determination is made as to whether or not a number of banknotes corresponding to the number of notes to be retrieved displayed on the retrieval note count confirmation screen have all been stored in the OP cassette 23.

For example, at step S207, determination is made as to whether or not all of the banknotes scheduled for retrieval have been retrieved, based on the number of banknotes of each denomination that have passed through the banknote classification section 27.

In cases in which the control section 31 determines at step S207 that all of the banknotes scheduled for retrieval have not been retrieved (step S207: NO), processing returns to step S205, and banknotes are conveyed from whichever of the recycling cassettes 22 for which retrieval has not been completed to the banknote deposit/withdrawal section 13 (step S205).

Namely, at step S205 to step S207, the control section 31 extracts banknotes from the recycling cassettes 22A to 22C, as a sixth conveyance, to convey banknotes from each of the recycling cassettes 22A to 22C, serving as first storage boxes, to the banknote deposit/withdrawal section 13, serving as a medium retention section. The control section 31 then stores the banknotes that have been extracted from the respective recycling cassettes 22A to 22C in the OP cassette 23, as a seventh conveyance, to convey banknotes from the banknote deposit/withdrawal section 13 to the OP cassette 23, serving as a second storage box.

In cases in which the control section 31 determines that all of the banknotes scheduled for retrieval have been retrieved at step S207 (step S207: YES), the control section 31 prints a retrieval outcome on a receipt slip (step S208), ends the retrieval routine RT2, and then repeats execution of the retrieval routine RT2.

For example, at step S208, the receipt slip printed with the denomination and numbers of banknotes conveyed to the OP cassette 23 is dispensed through the card insertion/return port 19. Note that there is no limitation to this example, and a retrieval outcome may be displayed on the display 11A as well as on the receipt slip. Alternatively, the retrieval outcome may be displayed on the display 11A without being output on a receipt slip, if required by the operator.

Note that in cases in which a “retrieve all” option is selected at step S204, all of the banknotes inside the recycling cassettes 22A to 22C may be retrieved by conveyance similarly to in the present routine. Alternatively, in cases in which the “retrieve all” option is selected at step S204, the present routine may be ended, and the recycling cassettes 22A to 22C may be removed and replaced with other recycling cassettes. For example, the “retrieve all” option may be selected in cases in which all of the recycling cassettes 22A to 22C have become full.

Note that although explanation has been given regarding an example in which banknote retrieval is performed using a single OP cassette 23, there is no limitation thereto. For example, in cases in which the number of banknotes to be retrieved exceeds the number that could be stored in a single cassette, two or more of the OP cassettes 23 may be employed. For example, after retrieving banknotes until one OP cassette 23 has become full, this OP cassette 23 may then be replaced with a different empty OP cassette 23 before continuing with the retrieval operation.

As described above, during a maintenance operation involving retrieval of banknotes, the ATM 100 enables an empty OP cassette 23 to be loaded, and banknotes from inside the recycling cassettes 22A to 22C to be classified by the banknote classification section 27 and stored in the OP cassette 23.

When this is performed, banknotes are temporarily held in the holding section 13B of the banknote deposit/withdrawal section 13. This enables uninterrupted conveyance in a single direction despite the layout described above, enabling efficient conveyance that passes through the banknote classification section 27.

Moreover, passage through the banknote classification section 27 enables a predetermined number of banknotes to be retrieved from the recycling cassettes 22A to 22C. Namely, simply loading the OP cassette 23 enables automatic and efficient retrieval of banknotes from inside the ATM 100.

Accordingly, for example, there is no need to remove all the cassettes subject to retrieval and replace them with other cassettes. Namely, fewer cassettes need to be prepared than in cases in which the cassettes subject to retrieval are removed and replaced with other cassettes, resulting in less effort being required for the retrieval operation.

Accordingly, the ATM 100 enables providing a device that reduces the number of cassettes required in order to retrieve the medium from inside the device, and that allows simple and reliable management of the medium inside the cassettes.

Moreover, similarly to in the case of auditing as described above, when performing retrieval according to the present exemplary embodiment, banknotes are either classified by the banknote classification section 27 on being fed out from the banknote deposit/withdrawal section 13, or classified when being conveyed from the banknote deposit/withdrawal section 13 to the OP cassette 23 (or to the banknote temporary detention section 29) (at the seventh conveyance). However there is no limitation to this example, and for example, banknotes may be classified when the banknotes are being conveyed from a recycling cassette 22 to the banknote deposit/withdrawal section 13 (at the sixth conveyance). Namely, it is sufficient for banknotes to pass through the banknote classification section 27 and be classified during either the sixth conveyance or the seventh conveyance. However, it is also possible to classify banknotes during both the sixth conveyance and the seventh conveyance, and so doing contributes to more credible classification.

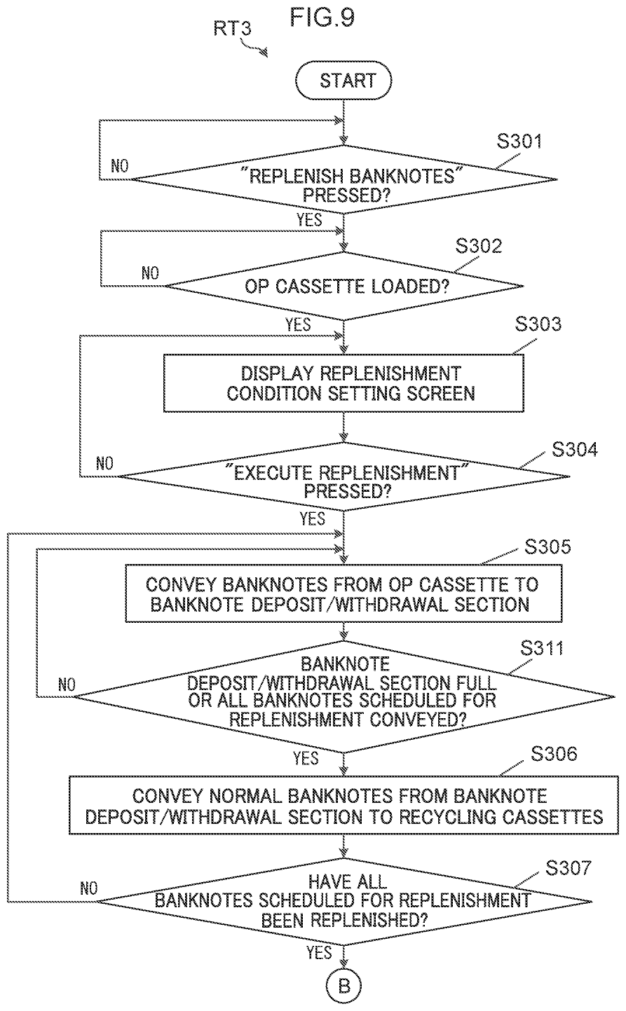

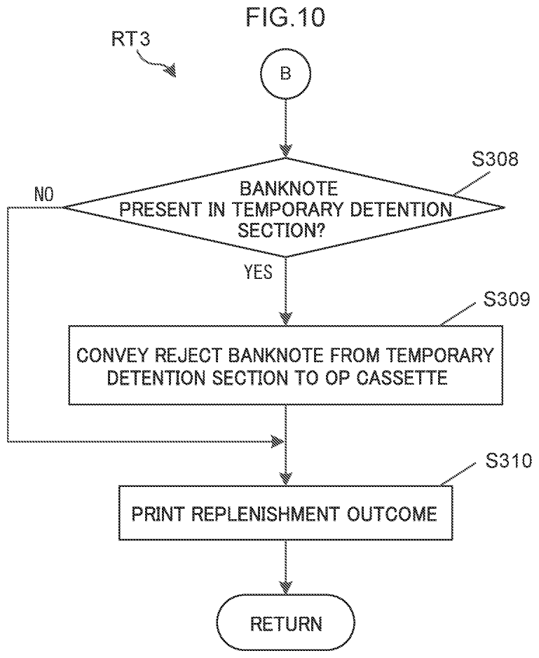

Explanation follows regarding a banknote replenishment routine RT3 executed by the control section 31 of the ATM 100, with reference to FIG. 9 and FIG. 10. Explanation follows regarding an example of a case in which banknotes are replenished in all of the recycling cassettes 22A to 22C included in the recycling cassette set 22.

The control section 31 starts the present routine when, for example, a specialist key has been used to switch an operation mode of the ATM 100 from the normal mode in which transactions are executed to a mode for executing processing related to maintenance operations.

After starting the replenishment routine RT3, the control section 31 determines whether or not a “replenish banknotes” option has been pressed (step S301). For example, at step S301, the control section 31 displays a maintenance operation selection screen on the display 11A of the operation/display section 11, and determines whether or not the “replenish banknotes” option displayed on the selection screen has been selected using the touch pad 11B. Note that as previously described, there is no limitation to this example, and for example hard keys may be employed instead of the touch pad 11B.

In cases in which the control section 31 determines that the “replenish banknotes” option has not been pressed at step S301, step S301 is repeated, and determination as to whether or not the “replenish banknotes” option has been pressed is performed again.

In cases in which the control section 31 determines that the “replenish banknotes” option has been pressed at step S301, the control section 31 determines whether or not the OP cassette 23 has been loaded (step S302). Namely, at step S302, the control section 31 determines whether or not the OP cassette 23, in which replenishment banknotes are stored, has been loaded to the ATM 100.

In cases in which the control section 31 determines that the OP cassette 23 has not been loaded at step S302, step S302 is repeated, and determination as to whether or not the OP cassette 23 has been loaded is performed again.

In cases in which the control section 31 determines that the OP cassette 23 has been loaded at step S302, the control section 31 displays a replenishment condition setting screen (step S303).

For example, the replenishment condition setting screen is used by the control section 31 to receive input specifying the number of replenishment banknotes of each denomination through the touch pad 11B. For example, an operator in charge of the maintenance operation may input “500” for 10,000 yen notes. In such cases, supposing the recycling cassette 22A already contains 490 of 10,000 yen notes, the number of replenishment banknotes may be set to 10. In such cases, if the recycling cassette 22A is preset to require 500 notes on replenishment, for example, the operator can be saved the effort of confirming the storage status of the recycling cassette 22A (i.e. how many banknotes are already stored in the recycling cassette 22A) prior to replenishment.

Alternatively, for example, at step S303 the control section 31 may display on the display 11A a display including the total number of banknotes of each denomination inside the recycling cassettes 22A to 22C, and a recommended number of replenishment banknotes for each denomination.

For example, the control section 31 may use a history of transactions executed on the ATM 100 within a predetermined timeframe to compute and display on the replenishment condition setting screen a number of banknotes to be replenished for each of the recycling cassettes 22A to 22C. For example, the appropriate number of banknotes to be replenished may be computed based on trends in deposits and withdrawals performed at the ATM 100 within a predetermined period, such that the respective cassettes will not become full, while maximizing the length of time until banknotes for withdrawals become insufficient. At step S303 the control section 31 functions as a second computation section.

After executing step S303, the control section 31 determines whether or not an “execute replenishment” option has been pressed (step S304). For example, at step S304, the control section 31 determines whether or not an “execute replenishment” option displayed on the replenishment condition setting screen has been selected using the touch pad 11B.

In cases in which the control section 31 determines that the “execute replenishment” option has not been pressed at step S304, processing returns to step S303, and display of the replenishment condition setting screen continues. Note that, for example, in cases in which a “cancel” option displayed on the replenishment condition setting screen has been selected at step S304, the control section 31 may end the current routine.

In cases in which the control section 31 determines that the “execute replenishment” option has been pressed at step S304, banknotes are conveyed from the OP cassette 23 to the banknote deposit/withdrawal section 13 (step S305). For example, at step S305, the control section 31 controls the conveyance section 25 to convey the number of banknotes specified for each denomination on the replenishment condition setting screen to the holding section 13B of the banknote deposit/withdrawal section 13.

Next, in cases in which the holding section 13B of the banknote deposit/withdrawal section 13 is full with stored banknotes, or all of the banknotes scheduled for replenishment have been conveyed from the OP cassette 23 to the holding section 13B (step S311: YES), step S306, described later, is executed. Alternatively, in cases in which at step S311 the holding section 13B is not full with stored banknotes and banknotes scheduled for replenishment are still present in the OP cassette 23 (for example, in cases in which the number of banknotes scheduled for replenishment has not yet been reached), step S305 is performed again.

Next, at step S306, the banknotes are for example conveyed from the banknote deposit/withdrawal section 13 so as to pass through the banknote classification section 27. At step S306, any banknotes from the banknote deposit/withdrawal section 13 classified as reject banknotes after passing through the banknote classification section 27 are for example conveyed to the banknote temporary detention section 29; however, there is no limitation to this example, and reject banknotes may for example be conveyed directly to the reject cassette 24.

The control section 31 conveys banknotes from the banknote deposit/withdrawal section 13 to the recycling cassettes 22A to 22C (step S306). For example, at step S306, the banknotes within the holding section 13B of the banknote deposit/withdrawal section 13 are classified and conveyed to the recycling cassettes 22A to 22C of the corresponding denomination.

After executing step S306, the control section 31 determines whether or not all of the banknotes scheduled for replenishment have been replenished (step S307). For example, at step S307, the control section 31 determines whether or not banknotes corresponding to the number of replenishment banknotes displayed on the replenishment condition setting screen for each denomination have all been stored in the recycling cassettes 22A to 22C of the corresponding denomination.

For example, at step S307, determination is made based on the classification results of the banknote classification section 27 as to whether or not all of the banknotes scheduled for replenishment have been replenished.

In cases in which the control section 31 determines that the banknotes scheduled for replenishment have not all been replenished at step S307 (step S307: NO), processing returns to step S305, and banknotes are conveyed from the OP cassette to the banknote deposit/withdrawal section 13.

Namely, at step S305 to step S307, the control section 31 extracts banknotes from the OP cassette 23, as a fourth conveyance, to convey banknotes from the OP cassette 23 serving as a second storage box to the banknote deposit/withdrawal section 13 serving as a medium retention section, and stores the banknotes that have been extracted from the OP cassette 23 in the recycling cassettes 22A to 22C, as a fifth conveyance, to convey banknotes from the banknote deposit/withdrawal section 13 to the recycling cassettes 22A to 22C serving as plural first storage boxes.

In cases in which the control section 31 determines that the banknotes scheduled for replenishment have all been replenished at step S307 (step S307: YES), as illustrated in FIG. 10, the control section 31 determines whether or not a banknote is present in the banknote temporary detention section 29 (step S308). For example, at step S308, the control section 31 determines whether or not any of the banknotes replenished during step S305 to step S307 have been classified as reject banknotes when passing through the banknote classification section 27 and have been retained in the banknote temporary detention section 29.

In cases in which the control section 31 determines that a banknote is detained in the banknote temporary detention section 29 at step S308 (step S308: YES), this reject banknote is conveyed from the banknote temporary detention section 29 to the OP cassette 23 (step S309). For example, detaching the OP cassette 23 enables the reject banknote to be removed from the ATM 100. There is no limitation to this example, and alternatively, for example, any reject banknotes in the banknote temporary detention section 29 may be conveyed to the reject cassette 24. In cases in which banknotes remain in the OP cassette 23 after replenishment, storing reject banknotes in the reject cassette 24 enables such reject banknotes to be prevented from mixing in with other banknotes in the OP cassette 23.

In cases in which the control section 31 determines that no banknotes are retained in the banknote temporary detention section 29 at step S308 (step S308: NO), or after executing step S309, the control section 31 prints a replenishment outcome (step S310), ends replenishment routine RT3, and then repeats execution of the replenishment routine RT3.

For example, at step S310, a receipt slip printed with the denominations and numbers of banknotes conveyed from the OP cassette 23 is dispensed through the card insertion/return port 19. A receipt slip may also be printed with the denominations and/or numbers of reject banknotes. The receipt slip may also be printed with the serial numbers of such reject banknotes.

As described above, during a maintenance operation involving replenishment of banknotes, the ATM 100 enables the OP cassette 23 storing replenishment banknotes to be loaded to allow replenishment of corresponding cassettes of the recycling cassettes 22A to 22C after classification by the banknote classification section 27.

When this is performed, banknotes are temporarily held in the holding section 13B of the banknote deposit/withdrawal section 13. This enables uninterrupted conveyance in a single direction despite the layout described above, enabling efficient conveyance that passes through the banknote classification section 27.

Moreover, passing banknotes through the banknote classification section 27 enables the denomination and number of replenishment banknotes to be confirmed based on the classification results, enabling the banknotes to be reliably stored in the appropriate cassette for the denomination. Namely, simply loading the OP cassette 23 enables automatic and efficient banknote replenishment inside the ATM 100.

Accordingly, for example, there is no need to remove all cassettes subject to replenishment and replace them with other cassettes in which replenishment banknotes are stored. Namely, fewer cassettes need to be prepared than in cases in which the cassettes subject to replenishment are removed and replaced with other cassettes, resulting in less effort being required for the replenishment operation.

Accordingly, the ATM 100 enables an automated transaction device to be provided that reduces the number of cassettes required in order to replenish the medium inside the automated transaction device, and that allows simple and reliable management of the medium inside the cassettes.

Moreover, similarly to in the cases of auditing and retrieval described above, when performing replenishment in the present exemplary embodiment, banknotes are either classified by the banknote classification section 27 on being fed out from the banknote deposit/withdrawal section 13, or classified when being conveyed from the banknote deposit/withdrawal section 13 to the recycling cassettes 22 (or to the banknote temporary detention section 29) (at the fifth conveyance). However there is no limitation to this example, and for example, banknotes may be classified when the banknotes are being conveyed from the OP cassette 23 to the banknote deposit/withdrawal section 13 (at the fourth conveyance). Namely, it is sufficient for banknotes to pass through the banknote classification section 27 and be classified during either the fourth conveyance or the fifth conveyance. However, it is also possible to classify banknotes during both the fourth conveyance and the fifth conveyance, and so doing contributes to more credible classification.

Although explanation has been given regarding an example in which banknotes classified as reject banknotes during the banknote replenishment routine RT3 are retained in the banknote temporary detention section 29, also in the auditing routine RT1 and the retrieval routine RT2, reject banknotes may be retained in the banknote temporary detention section 29 and conveyed to the OP cassette 23 after the end of each routine.

Alternatively, banknotes classified as reject banknotes in the above maintenance operations may be conveyed directly to the reject cassette 24 without being retained in the banknote temporary detention section 29. It is sufficient that by passing banknotes through the banknote classification section 27, reject banknotes may be prevented from remaining or being taken into in the recycling cassette set 22.

Note that although explanation has been given regarding an example in which banknotes serve as a medium, the present disclosure may similarly be applied to coins.

Moreover, although explanation has been given in the present exemplary embodiment of an example in which receipt slips are printed on a medium, there is no limitation to this example, and for example receipt slip data including execution outcomes may be stored on a recording medium such as USB memory or a DVD, or may be uploaded to a mobile terminal or server by a wired or wireless communications.

The configurations and routines described in the foregoing example are merely exemplary, and adaptations may be made as appropriate according to the intended purpose and so on.

1. A transaction device that executes transaction processing relating to a medium, the transaction device comprising:
a medium retention section capable of retaining the medium;
a plurality of first storage boxes capable of storing the medium;
a second storage box capable of storing the medium and that is detachable with respect to the transaction device;
a conveyance section capable of conveying the medium on a conveyance path connecting between the first storage boxes, the second storage box, and the medium retention section; and
a classification section provided on the conveyance path and capable of classifying the medium as the medium passes through,
wherein the conveyance section being configured to convey the medium from the first storage boxes to the second storage box or from the second storage box to the first storage boxes via the medium retention section and the classification section when performing retrieval, auditing, or replenishment.

2. The transaction device of claim 1, wherein during the auditing:
the conveyance section extracts the medium from one first storage box from of the plurality of first storage boxes by a first conveyance to convey the medium from the one first storage box to the medium retention section, and extracts the medium from the medium retention section and stores the conveyed medium in the second storage box by a second conveyance to convey the medium from the medium retention section to the second storage box; and
the medium is conveyed so as to pass through the classification section during either the first conveyance or the second conveyance.

3. The transaction device of claim 2, wherein the conveyance section returns the medium extracted from the one first storage box and stored in the second storage box to the one first storage box by a third conveyance that is performed after the second conveyance and that conveys the medium from the second storage box to the one first storage box.

4. The transaction device of claim 2, wherein a reject medium as classified by the classification section is conveyed to a reject storage box during either the first conveyance or the second conveyance.

5. The transaction device of claim 4, further comprising a temporary detention section, wherein:
the reject medium is conveyed to the reject storage box after having been temporarily detained in the temporary detention section.

6. The transaction device of claim 1, wherein during the replenishment:
the conveyance section extracts the medium from the second storage box by a fourth conveyance to convey the medium from the second storage box to the medium retention section, and stores the medium that has been extracted and conveyed from the second storage box in at least one of the first storage boxes by a fifth conveyance to convey the medium from the medium retention section to the at least one of the first storage boxes; and
the medium is conveyed so as to pass through the classification section during either the fourth conveyance or the fifth conveyance.

7. The transaction device of claim 6, further comprising a temporary detention section provided on the conveyance path and capable of temporarily retaining the medium as the medium passes through the conveyance path, wherein:
the conveyance section causes a reject medium classified as a counterfeit note or a damaged note by the classification section during the auditing or the replenishment to be retained in the temporary detention section.

8. The transaction device of claim 7, wherein the reject medium is conveyed from the temporary detention section to a reject storage box.

9. The transaction device of claim 3, further comprising a first computation section configured to compute a quantity of the medium to be extracted from each of the plurality of first storage boxes during the auditing based on a history of transaction processing executed within a predetermined timeframe.

10. The transaction device of claim 6, further comprising a second computation section configured to compute a quantity of the medium to be stored in a given first storage box of the plurality of first storage boxes by the fifth conveyance during the replenishment based on a history of transaction processing executed within a predetermined timeframe.

11. The transaction device of claim 1, wherein during the retrieval:
the conveyance section at least extracts the medium from the first storage boxes by a sixth conveyance to convey the medium from the first storage boxes to the medium retention section, and extracts the medium from the medium retention section and stores the medium in the second storage box by a seventh conveyance to convey the medium from the medium retention section to the second storage box; and
the medium is conveyed so as to pass through the classification section during either the sixth conveyance or the seventh conveyance.

12. The transaction device of claim 11, wherein in cases in which a reject medium has been classified by the classification section, information regarding the reject medium is output on a receipt slip and/or on a screen.

13. The transaction device of claim 11, further comprising a temporary detention section, wherein:
a reject medium classified by the classification section is temporarily detained in the temporary detention section and then stored in either a reject storage box or the second storage box; and
information regarding the reject medium is output on a receipt slip and/or on a screen.
